(19) United States
(12) Patent Application Publication
(10) Pub. No.: US 2005/0244796 A1
(43) Pub. Date: Nov. 3, 2005

(54) Motion simulator with exchangeable unit

(75) Inventors: Jan Albert Mulder, Pijnacker (NL); Adriaan Beukers, Heemstede (NL); Max Baarspul, Nieuwkoop (NL); Michael Johannes L. van Tooren, Delft (NL); Stefaan Emiel E. de Winter, Zoetermeer (NL)

Correspondence Address: MICHAELSON AND WALLACE;PARKWAY 109 OFFICE CENTER, 328 NEWMAN SPRINGS RD, P O BOX 8489, RED BANK, NJ, 07701, US

(73) Assignee: Technische Universiteit Delft

(21) Appl. No.: 11/084,432

(22) Filed: Mar. 18, 2005

Related U.S. Application Data
(63) Continuation of application No. 10/221,535, filed on May 15, 2003, now abandoned.

(30) Foreign Application Priority Data
Mar. 13, 2000 (NL) 1014625

(51) Int. Cl. G09B 9/02

(52) U.S. Cl. 434/58

(57) ABSTRACT

A motion simulator provided with a movable housing, preferably carried by a number of length-adjustable legs, in which housing projection means are arranged for visual information supply, while in the housing a control environment of a motion apparatus to be simulated is situated, the control environment being incorporated in a removable unit, which unit is exchangeable for another, comparable unit having a different control environment to be simulated.

The invention relates to a motion simulator. The invention relates in particular to a motion simulator with which motions of different control environments can be simulated. Such a motion simulator is known, for instance, from U.S. Pat. No. 5,829,982.

This known motion simulator comprises a housing carried on six length-adjustable legs. Through active regulation of the length of the legs, specifically under the influence of control signals from a control environment incorporated in the housing and algorithms in an arithmetic unit coupled therewith, motions of the control environment can be faithfully simulated therewith. As a result, for instance, training sessions can be provided for operators (e.g. drivers or pilots) of vehicles such as aircraft, without requiring flying in a real vehicle. As a consequence, safety is enhanced, costs are reduced and moreover the environment is not affected.

In this known motion simulator, with the aid of real components from a vehicle, at least control environment, to be simulated, and mock-up parts, in particular decor items from wood, metal, plastic and the like, a control environment has been imitated, such that it corresponds to a large extent to the real control environment. This provides the advantage that in the same housing different control environments can be built up, which renders the motion simulator universally applicable, in particular also in that the motion simulator is carried by the six legs such a manner as to have six degrees of freedom. Within the housing, means are provided for projecting images of a simulated environment, which is influenced inter alia by signals from the control means of the control environment and the associated motions of the motion simulator.

This known motion simulator has as a disadvantage that each time when a different control environment is to be simulated, all parts of the previously simulated control environment are to be removed, whereafter in the cleared space within the housing an entirely new control environment must be built up. This is particularly time consuming and specifically disadvantageous when the motion simulator is frequently used for different applications, for instance as a test or instruction simulator for vehicles such as aircraft.

The object of the invention is to provide a motion simulator of the type described in the preamble, whereby the disadvantages mentioned are avoided, while maintaining the advantages thereof. To that end, a motion simulator according to the invention is characterized by the features of claim 1.

In a motion simulator according to the invention, in the housing, those elements are arranged that are to be used for every simulation, such as projecting means, arithmetic units optionally moving along, and the like. Naturally, other items may be arranged (semi) permanently within the housing, such as ballast means, a workplace for a supervisor, setup means and the like. Further included within the housing are means in which a removable unit can be placed, which is exchangeable for another unit, at least one compatible with the receiving means. In the unit included within the housing, a control environment is built up, which is a faithful copy of the control environment to be simulated. This unit is in its entirety placeable within the housing, such that the unit moves along with the motions of the housing. Naturally, the unit is designed such that images projected with the aid of the projection means are visible from a control position within the unit. Within the housing, the unit can be simply coupled to the control apparatus of the motion simulator. When subsequently motions of a different control environment are to be simulated, the unit extending in the housing can be simply removed and exchanged for the unit required or the other control environment, in which unit the respective control environment is built up, at least arranged. Preferably, in each unit, only that part of a relevant environment is included which is relevant to the operation of the control unit, for the field of vision thereof and the like, As a consequence, the required volume and the associated weight of the unit can be reduced considerably, while yet an accurate simulator can be obtained.

‘Control environment’ is herein to be understood to include at least operating positions of an operator of a vehicle, including body parts extending in the immediate surroundings thereof, as well as operating means such as steering wheel, dashboard with control buttons, pedals and the like. This can be, for instance, a nose part of an aircraft, a part of an automobile in which the driver and, for instance, a passenger are present, or the like, including windows. It may also be a workplace of an operator of, for instance, an industrial apparatus, a ship or the like.

Surprisingly, it has been found that by making use of thus built-up units that are rapidly and simply exchangeable, a motion simulator can be obtained which despite the weight of the unit can yet simulate motions particularly accurately.

In a motion simulator according to the invention, preferably, the center of gravity of the housing with the unit received therein is located as closely as possible to, and preferably in, the plane defined by at least three and preferably six suspension points of the housing. When using three pairs of length-adjustable legs, such a plane is therefore defined by at least three of the pivoting coupling points of the legs to the housing. As a result, response times of the motion simulator can be reduced to a minimum.

In a particularly advantageous embodiment, a motion simulator according to the invention is further characterized by the features of claim 6.

In such an embodiment, a unit can be simply placed within the housing by sliding it in via an insertion opening. In particular the front part of the unit can then be made of a relatively random shape, for instance in conformity with the respective body part of a vehicle to be simulated, while the part of the unit in trailing position in the insertion opening can have a standardized shape, such that it fits specifically arranged compatible connecting means of the simulator. Preferably, the insertion opening is then at least substantially closed off by the rearward end of the unit.

By providing on the inside of the housing a projection surface, preferably an integral part of the wall of the housing, opposite the insertion opening, it is possible, in a simple manner, to present images to a user within the unit, using projecting means which may be arranged at suitable positions within the housing, for instance above or next to the unit, so that they remain outside the field of vision of the user, while a relatively compact housing can be obtained. Naturally, the images represented by the projection means will be influenced, during use, on the basis of operating signals delivered by the user and algorithms in an arithmetic unit coupled therewith, by means of which algorithms motions of the respective vehicle, at least the control environment, are simulated faithfully.

In a particularly advantageous embodiment, a motion simulator according to the invention is characterized by the features of claim 7.

In this embodiment, integral control environments separated from existing vehicles, at least intended for use therein, are used as main constituent of a unit, while standard elements are added for simply coupling the unit to the further motion simulator. These standard elements can form, for instance, a rear part of the unit, with which, in addition, the unit can be closed off. In this element, for instance connecting means and an access door can be provided.

It is preferred that a motion simulator according to the invention, at least the moving part thereof, is relatively light, but stiff in construction. To that end, in a particularly advantageous embodiment, the housing is built up from plastic shell parts, preferably as a monocoque, or which purpose in a particularly advantageous manner sandwich panels can be used. As a result, occurring forces, response times and the like can be reduced still further.

The invention further relates to an assembly of a motion simulator and a series of units, characterized by the features of claim 10.

By providing a series of units, all compatible with connecting means of a motion simulator, with each unit built up as a control unit or comprising such a control unit, while the control environments in the different units differ from each other, it is possible in a simple manner to simulate with a single motion simulator a large number of different control environments, such as vehicles, at least the motions thereof. As the units can be exchanged integrally and rapidly, conversion times are reduced to a minimum, errors are simply avoided and good simulations are ensured.

The invention further relates to a method for simulating motions of a control environment, characterized by the features of claim 13.

With such a method, the advantage is achieved that different control environments, in particular vehicles, in particular also the motions thereof, can be simulated rapidly and simply with a motion simulator in a highly faithfull manner.

In the further subclaims, further advantageous embodiments of a motion simulator according to the invention are described

To clarify the invention, exemplary embodiments of a motion simulator and a method according to the invention will be described with reference to the drawing. In the drawing:

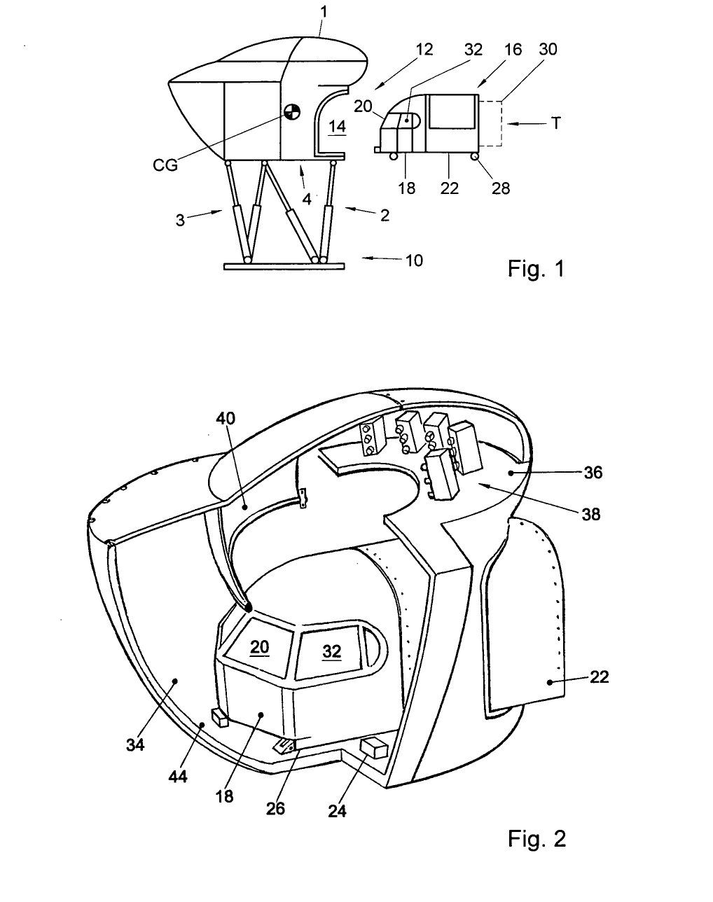

FIG. 1 schematically shows, in side elevation, a flight simulator with a unit to be placed therein;

FIG. 2 shows in partly cutaway perspective view, a motion simulator with a unit therein;

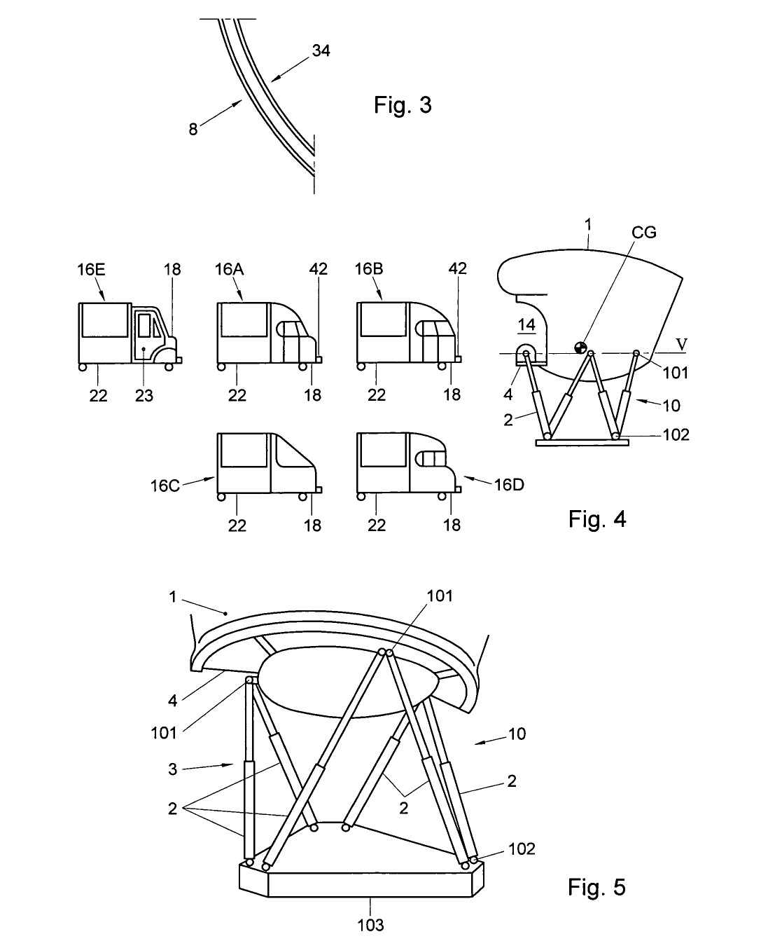

FIG. 3 shows, in cross section, a portion of a wall of the housing of a simulator according to FIG. 2;

FIG. 4 shows a motion simulator with a series of units; and

FIG. 5 shows, in perspective view, an example of a motion undercarriage of a motion simulator according to the invention.

In this description, a choice has been made for an embodiment of a motion simulator with which aircraft, at least aircraft motions, can be simulated This embodiment has been chosen only by way of example. It will be clear, however, that a motion simulator according to the invention can also be used for many other control environments, as of vehicles. In fact, different kinds of control environments can be simulated with the same motion simulator, for instance aircraft, automobiles, boats and the like. A control environment should herein be understood to encompass at least a portion of a layout in which a driver, at least an operator, is present during operation, including relevant operating means, supporting means, surrounding body parts and the like. The control environment can be built up using authentic parts from the existing environment such as a vehicle, placed within a specifically build-up unit. Also a portion of, for instance, a vehicle whose motions are to be simulated can be used. Thus, for instance, (a portion of) a cockpit of an airplane or a driver's environment of an automobile can be detached and be used. The control means, information devices such as speed, pressure and position indicators are provided with electronic means by means of which they can be coupled with an arithmetic unit such as a computer, so that information can be faithfully represented.

FIG. 1 shows, in side elevation, an embodiment of a motion simulator according to the invention, with a housing 1 supported on six legs 2, divided into three pairs 3. FIG. 5 schematically shows a configuration of the three pairs 3 of legs 2, together with a portion of a platform 4 which can form an integral part of the housing 1 or on which the housing 1 is built up.

The platform 4 is connected via the upper pivots 101 with the legs 2, while adjacent the lower ends the legs 2 are connected via second pivots 102 with a substantially triangular base plate 103. Of each pair 3 of legs 2, the lower pivots 102 are placed relatively close to each other, while the upper pivots 101 of one leg of two adjacent pairs 3 are placed relatively close to each other adjacent the platform 4. Each leg 2 comprises, as schematically shown, an assembly of a double-acting, hydraulic drivable piston and cylinder, by means of which the length of each leg 2 is dynamically adjustable. When the motion simulator has been brought into a central position, as approximately shown in FIG. 5, each pair of mutually adjacent first pivots 101 extends approximately above the middle between two mutually adjacent second pivots 102. From this position, the platform 4 can be moved in any desired direction through suitable length adjustment of the legs 2, which can be obtained in any suitable manner by means of hydraulic drive means, known per se (not shown). Such an undercarriage as such is described in more detail in U.S. Pat. No. 5,829,982, incorporated herein by reference.

In the embodiment shown in FIG. 1, the platform 4 is substantially flat at the underside and is carried on the upper pivots 101 of the legs 2. The housing 1 is preferably built up from largely plastic shell parts, with a wall 8 having a sandwich structure, as represented in FIG. 3, which will be further elucidated hereinafter. As a result of, in particular, the plastic sandwich panels, a particularly light, stiff construction is obtained, so that relatively little force is required for the motions of the simulator and relatively short response times can be obtained and high accelerations and decelerations can be used, while the range of motion is large. What is thus prevented, moreover, is that in the use of the motion simulator undesired reaction forces arise, for instance as a result of its own vibrations and the like. It is incidentally noted that other configurations can be used for a movement undercarriage 10 of the motion simulator, for instance as described in NL 1006741, EP 0 784 889, U.S. Pat. No. 5,975,907 and JP-A-3-274587, incorporated herein by reference. Preferably, a motion simulator according to the invention has six degrees of freedom.

The housing 1 is substantially close such that no light falls in from the outside. At the back 12, in FIG. 1 on the right-hand side, an insertion opening 14 is provided, through which a unit 16 can be slid, into a position in which it extends at least largely within the housing. The unit 16 is built up from a front part 18 in which substantially the control environment 20 is incorporated (seats, dashboard, steering means, displays, indicators and the like), and a rear part 22 which forms an experiment module. In it, an apparatus specific for the respective control environment 20 is included, comprising inter alia an arithmetic unit in the form of a computer (not shown), with which, for instance, operating signals from the operating means can be converted to standard signals suitable to be processed by a central control unit 24 within the housing. Each unit 16 is provided with such an experiment module 22, which experiment modules 22 are preferably identical in shape and so dimensioned that the insertion opening is sealed thereby, while the output signals are standardized. In addition, signals produced by the central control unit 24 are converted by the arithmetic unit in the experiment module 22 to signals suitable or the respective control environment 20. Within the housing 1, guide rails 26 are arranged, on the platform, along which the units 16 can be guided with suitable running means, such as slide blocks or rollers 28, so that they can be simply brought inside and outside the housing. In the rearward side, viewed in the insertion direction T, the experiment module is provided with a door 30, through which users can enter or leave the control environment 20 and the experiment module 22.

In the assembled condition, the center of gravity CG of the part of the motion simulator carried by the legs 2 is, at least in top plan view, preferably located between the upper ends of the legs 2, in particular approximately centrally therebetween, so that an equal distribution of forces can be obtained with the legs in a central position. However, the location of the center of gravity CG can also be positioned such that, in the normal use of the motion simulator, it is located between the lower ends of the legs 2 for a maximum time. Adjusting means such as ballast means (not shown) can be provided, with which the location of the center of gravity CG can be adjusted, preferably in three mutually perpendicular directions.

Such means are described, for instance, in U.S. Pat. No. 5,829,982, incorporated. herein by reference.

At the front, each unit is provided with windows 32 or like means determining the field of vision, whose configuration substantially corresponds to that of the real, existing control environment. In the embodiment shown, these are therefore the windows of an airplane to be simulated. This means that a user seated in the control environment 20 has a field of vision both inside and outside the unit 16 that corresponds to that of a real airplane. On the inside of the housing 1, on the side opposite the insertion opening 14, a mirror 34 is provided, which is preferably of double-curved design, with the concave side facing the unit 16, at least the insertion opening 14. The mirror is preferably of the rigid type and forms an integral part of the housing, as shown in FIG. 3. The mirror can optionally have a bearing function. ‘Mirror’ should herein be understood to encompass at least mirroring surfaces which can be fixed against the inside, for instance by gluing, or can be formed thereon, for instance through evaporation, polishing operations or the like. In the embodiment shown in FIG. 3, the wall is built up from a foamed inner layer, covered on opposite sides by an outer layer of preferably a relatively stiff plastic or metal layer, while the mirror 34 can form one of the outer layers mentioned or is provided thereon.

Above the insertion opening 14 there is provided a supporting surface 36 on which five projectors 38 are arranged. With these projectors, images can be projected on the mirror 34, visible to the user mentioned earlier. The projectors are coupled to the central control unit 24, so that the images can be influenced by, on the one hand, the operating signals coming from the unit 16 and, on the other, by the algorithms in the central control unit 24. As a result, faithfull images can be obtained. An auxiliary screen 40 extending from the upper side of the housing 1 above the unit 16 provides for a good image distribution and prevents adverse incidence of light. Auxiliary screen 40 is the so-called “Back Projection Screen”, from which the image formed by the projectors is reflected by the double concave (parabolic) mirror for obtaining improved depth.

In FIG. 4 an alternative embodiment of a motion simulator according to the invention is shown together with four units 16A-D. Each unit 16A-D comprises an experiment module 22, which experiment modules 22 are similar in shape, preferably identical to each other. In each case, the front part 18 is substantially shaped as a respective part of a vehicle, in the embodiment shown cockpits (at least parts thereof) of different aircraft.

Thus, for instance, the units 16A and 16B can have a front part 18 in the form of a mockup of a cockpit of an airliner, unit 16C a front part 18 in the form of a cockpit of a jet plane and 16D the cockpit of a helicopter. Further, in FIG. 4, a fifth unit 16E is shown, where a part of an automobile, of which a door 23 is visible, has been fitted on the experiment module 22. The rear part of the automobile and the engine compartment have been removed, leaving only the portion for seating the driver and optionally a passenger. In a comparable manner, other control environments 22 can be included in front parts 18, for instance of a ship, a chemical plant or the like. Each of these units 16 can be simply slid into the housing 1 via the opening 14, onto the platform 4. In this embodiment, the housing 1 is suspended in the form of a monocoque shell between the upper pivots 101 of the legs 2, such that the center of gravity CG of the assembly of at least housing 1 and unit 16 is located approximately between the upper pivots 101 of the legs 2, in a plane V determined therefor. Here too, ballast means can be provided again for further adjustment thereof.

It is preferred that the units 16 are provided with first connecting means 42, which, when inserting the units, are coupled directly to the second connecting means 44 within the housing 1, such that automatically at least one electronic coupling and optionally identification of the unit and the flight simulator is obtained. As a result, errors are simply prevented and a detachable coupling is readily obtained. In the drawing, (FIG. 4 and FIG. 2), the first and second coupling means 42, 44 are schematically represented adjacent the front of the unit, but it will be clear that these can naturally be fitted at different positions, for instance on the experiment module 22. Also, connecting means may be fitted on cords or be provided through wireless communication.

A flight simulator according to the invention can be used as follows.

Via the insertion opening 14, there is slid into the housing 1 a unit 16 having therein a control environment 20 of a vehicle whose motions are to be simulated. In the central control unit 24, algorithms are inputted, or selected, which are directed to the respective vehicle, such that specific motion characteristics can be simulated. Further, the images to be projected are loaded therein. Thereafter, an operator is seated in the control environment 20, such that he can observe through the windows 32 the images projected onto the mirror 84 with the projectors 38. The housing 1 is closed light-tightly by the experiment module 22 extending in the insertion opening 14, so that scattered light is avoided. Thereafter, the motion simulator is set in motion, while the central control unit 24 actively controls the length of the legs 2, inter alia under the influence of operating signals (or the very absence thereof) generated by the operator. Thus, a particularly faithful simulation of vehicle motions can be obtained. After use, the unit 16 can be simply pulled from the housing 1 and be exchanged for another unit 16, for simulating another vehicle.

The invention is not limited in any way to the exemplary embodiments shown in the description and the drawings. Many variations thereon are possible within the scope of the invention as outlined by the claims.

In the drawing, an insertion opening is provided, allowing the unit to be slid in a direction T into the housing, approximately parallel to the normal direction of travel of the vehicle to be simulated. As a result, a proper weight distribution is obtained. It will be clear, however, that other insertion direction can be chosen, such as, for instance, laterally or from below. In the exemplary embodiments shown, each unit 16 has a closed front end 18. However, this can also be wholly or partly open. The housing 1 can be built up differently, for instance from metal or plastic constructional elements, such as lattice, honeycomb panels or the like. The projectors 38 can also be arranged at different positions, for instance next to the unit 16, as long as they remain outside the view of the user. The central control unit 24 can also be placed outside the housing and be coupled with the unit 16 through suitable connecting means such as cables, radio connections or the like.

These and many comparable variations are understood to fall within the scope of the invention outlined by the claims.

1. A motion simulator, provided with a movable housing, preferably carried by a number of length-adjustable legs, in which housing projection means are arranged for visual information supply, while in the housing a control environment of a movement apparatus to be simulated is situated, characterized in that the housing is provided with an insertion opening and the control environment is incorporated in a removable unit which unit is exchangeable, via the insertion opening, for another, comparable unit having a different control environment to be simulated, and wherein each unit and the motion simulator are equipped with standardized connecting means with which the units can be coupled to the motion simulator.

2. A motion simulator according to claim 1, wherein the connecting means are arranged for connecting different operating means of the respective control environment to a central control unit arranged in or adjacent to the motion simulator, outside the respective unit.

3. A motion simulator according to claim 1, wherein at least one and preferably each of the exchangeable units is formed as a copy, faithful at least as regards the control environment, of the vehicle, at least the apparatus to which the respective control unit belongs.

4. A motion simulator according to claim 4, provided with a unit in the form of a cockpit of a vehicle, which cockpit comprises at least the operating means, the seating means and the windows in the configuration corresponding to that of the real vehicle, while during use the information represented by the projection means preferably can be read on the inside of the housing through said windows.

5. A motion simulator according to claim 1, wherein the housing, on a first side thereof, is provided with an insertion opening through which a unit can be placed in the housing, while on the inside of the housing a projection surface is provided on which, by means of the projection means, images can be projected which are at least influenced by control signals delivered by a user, using an arithmetic unit coupled to the unit.

6. A motion simulator according to claim 1, wherein the or each unit comprises at least a cockpit, at least a control environment, separated from a vehicle, and is preferably substantially formed thereby.

7. A motion simulator according to claim 1, wherein at least the housing is, and preferably the housing and the platform are, built up as, at least from, plastic shell parts, preferably as monocoque.

8. A motion simulator according to claim 1, wherein at least the housing is, and preferably the housing and the platform are, manufactured using sandwich panels.

9. An assembly of a motion simulator and a series of units, characterized that each unit a control environment is built up or is substantially formed thereby, the motion simulator being provided with receiving means for one of the units from the series, and each of the units can be selected depending on a control environment to be simulated, wherein each of the units is provided with first connecting means, compatible with second connecting means arranged in he motion simulator, such that upon placement of a unit in or on the motion simulator, the first and second connecting means are coupled for at least one electronic coupling.

10. An assembly according to claim 9, wherein the units each comprise a cockpit of an aircraft.

11. A method for simulating motions of a control environment utilizing a motion simulator provided with a movable platform, characterized in that a faithful copy of the control environment is received in a unit or is used as a unit, which unit is disposed on the platform, at least partly within a housing formed on the platform, and the unit is coupled to an arithmetic unit, such that through operating means of the control environment and algorithms included in the arithmetic unit, motions of the platform can be controlled, and for changing the environment to be simulated, the unit is removed from the simulator and is replaced with another unit, comprising a different control environment.
